(19) United States
(12) Patent Application Publication
(10) Pub. No.: US 2026/0229073 A1
(43) Pub. Date: Aug. 6, 2026

(54) DRIVING DIAGNOSIS APPARATUS AND DRIVING DIAGNOSIS PROGRAM

(71) Applicant: Honda Motor Co., Ltd., Tokyo (JP)

(72) Inventor: Masayuki Sato, Saitama (JP)

(21) Appl. No.: 19/455,283

(22) Filed: Jan. 21, 2026

(30) Foreign Application Priority Data
Feb. 3, 2025 (JP) 2025-016294

(51) Int. Cl. G07C 5/04; G01S 5/02

(52) U.S. Cl. CPC G07C 5/04; G01S 5/0247

(57) ABSTRACT

A driving diagnosis apparatus includes: an in-vehicle device provided in a vehicle and including a processor and a memory coupled to the processor. The in-vehicle device is configured to perform: performing communication with a first information terminal possessed by a first occupant riding in the vehicle and a second information terminal possessed by a second occupant riding in the vehicle; acquiring, through the communication, first information indicating a behavior of the vehicle detected by the first information terminal and second information indicating the behavior of the vehicle detected by the second information terminal; generating a driving evaluation value based on the first information and the second information; and performing a driving diagnosis of the first occupant driving the vehicle using the driving evaluation value.

### CROSS-REFERENCE TO RELATED APPLICATION

This application is based upon and claims the benefit of priority from Japanese Patent Application No. 2025-016294 filed on February 3, 2025, the content of which is incorporated herein by reference.

### BACKGROUND OF THE INVENTION

### Field of the Invention

The present invention relates to a driving diagnosis apparatus and a driving diagnosis program that diagnoses driving of a driver.

### Description of the Related Art

As this type of technology, there is known a technology of performing model estimation of a driving behavior based on acceleration information, rotation speed information, and the like acquired from a sensor provided in a mobile terminal in a vehicle (JP7459891B2).

In the conventional technology, appropriate driving diagnosis is not necessarily performed by simply using the information obtained by a sensor of a mobile terminal. Appropriate driving diagnosis is expected to greatly contribute to traffic safety.

### SUMMARY OF THE INVENTION

An aspect of the present invention is a driving diagnosis apparatus, including: an in-vehicle device provided in a vehicle and including a processor and a memory coupled to the processor. The in-vehicle device is configured to perform: performing communication with a first information terminal possessed by a first occupant riding in the vehicle and a second information terminal possessed by a second occupant riding in the vehicle; acquiring, through the communication, first information indicating a behavior of the vehicle detected by the first information terminal and second information indicating the behavior of the vehicle detected by the second information terminal; generating a driving evaluation value based on the first information and the second information; and performing a driving diagnosis of the first occupant driving the vehicle using the driving evaluation value.

Another aspect of the present invention is a non-transitory computer-readable recording medium storing a driving diagnosis program that, when executed by a computer, causes the computer to perform: performing communication with a first information terminal possessed by a first occupant riding in a vehicle and a second information terminal possessed by a second occupant riding in the vehicle; acquiring, through the communication, first information indicating a behavior of the vehicle detected by the first information terminal and second information indicating the behavior of the vehicle detected by the second information terminal; generating a driving evaluation value based on the first information and the second information; and performing a driving diagnosis of the first occupant driving the vehicle using the driving evaluation value.

### BRIEF DESCRIPTION OF THE DRAWINGS

The objects, features, and advantages of the present invention will become clearer from the following description of embodiments in relation to the attached drawings, in which:

FIG. 1 is a schematic diagram illustrating an example of a vehicle equipped with an IVI system;

FIG. 2A is a block diagram illustrating a configuration of a main part of an in-vehicle device;

FIG. 2B is a block diagram illustrating a configuration of a main part of a terminal;

FIG. 3 is a flowchart describing an example of driving diagnosis processing by a program; and

FIG. 4 is a block diagram illustrating a configuration of a main part of the terminal according to a first modified example.

### DETAILED DESCRIPTION OF THE INVENTION

### Overview

A driving diagnosis apparatus according to the invention diagnoses driving by a driver who drives a vehicle. In the embodiment, the driving diagnosis is performed based on the information indicating the behavior of the vehicle detected by the sensors provided in the information terminals such as the smartphones possessed by each of the plurality of occupants in the vehicle including the driver while the vehicle is traveling.

In general, in the driving diagnosis using a sensor of a smartphone, there is a concern that accuracy of diagnosis may be deteriorated as compared with a case where information detected by an acceleration sensor or the like on the vehicle side is used because the smartphone is not firmly fixed to a vehicle body, or the like.

There may be a difference in detected acceleration between a front seat (driver's seat) on which a driver sits and a rear seat on which, for example, a passenger sits. Actually, in a case where the positions of the seats are away from the center of gravity of the vehicle, a difference in acceleration is likely to occur among the plurality of seats.

For the reasons described above, in the embodiment, a plurality of pieces of information detected by the sensor of each terminal are acquired from a plurality of terminals used by a plurality of occupants, and driving diagnosis is performed based on the plurality of pieces of information.

For example, in a case where high acceleration is detected in all the plurality of terminals, it is determined that rough driving has been performed, and the driving diagnosis evaluation is lowered. In addition, in a case where high acceleration is detected only in some terminals of the plurality of terminals, there is a possibility of an individual factor (e.g., one of the terminals is not fixed to the vehicle etc.), and thus driving diagnosis is stopped based on an idea that it is better not to make an erroneous diagnosis.

In the embodiment, a driving diagnosis apparatus is exemplified as one of functions of an In-Vehicle Infotainment (IVI) system provided in a vehicle. The driving diagnosis apparatus diagnoses and evaluates driving characteristics of the driver of the vehicle based on a plurality of pieces of acceleration data detected by sensors of a plurality of terminals used by a plurality of occupants. Note that, in order to detect the posture of each terminal, a plurality of pieces of angular velocity data detected by the sensor of each terminal is also acquired.

The information obtained by the driving diagnosis apparatus may be managed by the IVI system for each driver. Such a driving diagnosis apparatus will be described in more detail with reference to the drawings.

### Configuration Example of Driving diagnosis apparatus

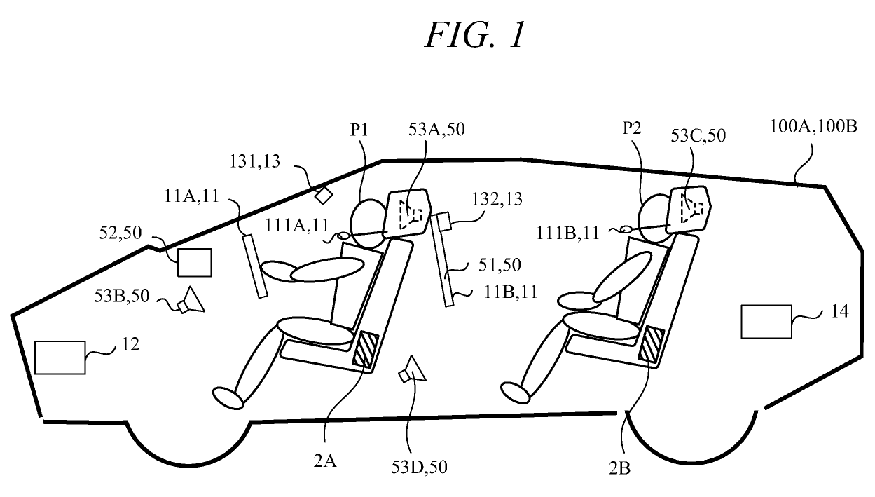

FIG. 1 is a schematic diagram illustrating an example of a vehicle 100 equipped with an IVI system including a driving diagnosis function as one of the functions. In the following description, an occupant who drives the vehicle 100 is referred to as a driver P1, and another occupant who rides together is referred to as a passenger P2.

The IVI system includes an in-vehicle device 14, a vehicle sensor group 12, a display unit 51, a projection unit 52, and voice reproduction units 53A to 53D constituting an output device 50, operation detection units 11A and 11B and microphones 111A and 111B constituting an input device 11, a front seat camera 131 and a rear seat camera 132 constituting a vehicle interior camera 13, a terminal 2A used by the driver P1 in a front seat of the vehicle interior, and a terminal 2B used by the passenger P2 in a rear seat of the vehicle interior. FIG. 1 illustrates a case where the driver P1 and the passenger P2 are seated in the vehicle interior.

The in-vehicle device 14 and the terminals 2A and 2B are configured to be able to perform, for example, Ultra-Wide Band (UWB) wireless communication. The UWB wireless communication is a communication system that enables highly accurate positional measurement using an ultra-wide band frequency bandwidth. In the embodiment, the positions of the terminals 2A and 2B in the vehicle interior can be detected with high accuracy.

The in-vehicle device 14, the output device 50, the input device 11, the vehicle sensor group 12, and the vehicle interior camera 13 are configured to be able to perform wired communication by a Controller Area Network (CAN) or the like.

The terminals 2A and 2B are, by way of example, smartphones or the like used by each of the driver P1 and the passenger P2. The terminals 2A and 2B are fixed to, for example, a holder (not illustrated) installed on a seat or the like on which each person sits.

Although two terminals 2A and 2B are illustrated as terminals used by the driver P1 and the passenger P2, the actual number of terminals varies depending on the number of occupants, and may be four if there are four occupants. In addition, the number of cameras constituting the vehicle interior camera 13, the number of operation detection units and microphones constituting the input device 11, and the number of display units, projection units, and voice reproduction units constituting the output device 50 may also be appropriately changed according to the number of occupants.

In the IVI system, if a button corresponding to the driving diagnosis is touch-operated from among a plurality of menu buttons (that may be referred to as icons) displayed on the output device 50, or if a voice corresponding to the driving diagnosis is input from the microphones 111A and 111B constituting the input device 11 in a state where the output device 50 (projection unit 52, display unit 51) is caused to project or display an operation menu screen (not illustrated), the in-vehicle device 14 starts an operation as the driving diagnosis apparatus 200.

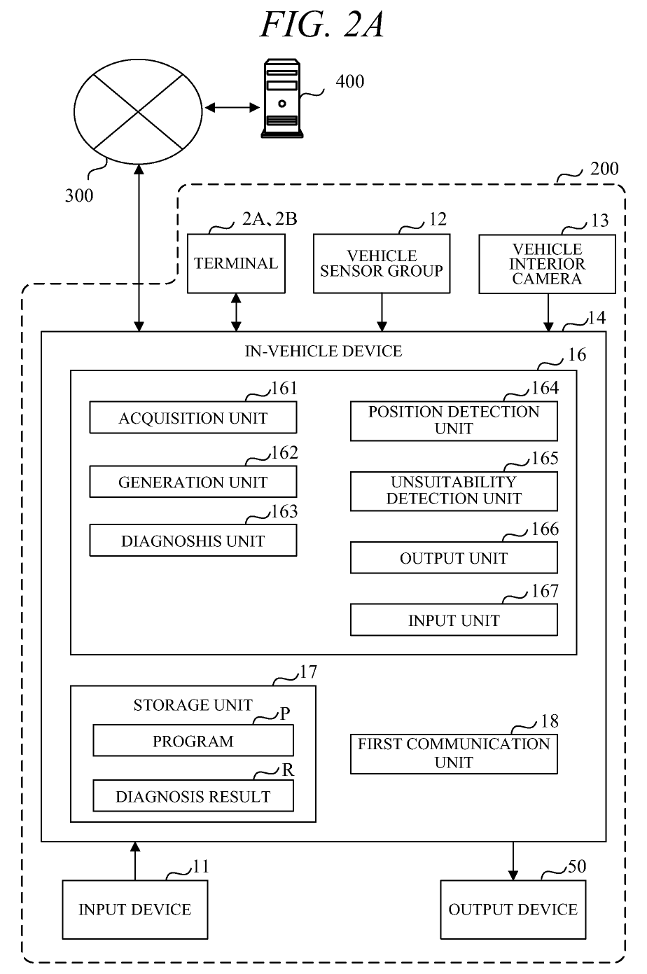

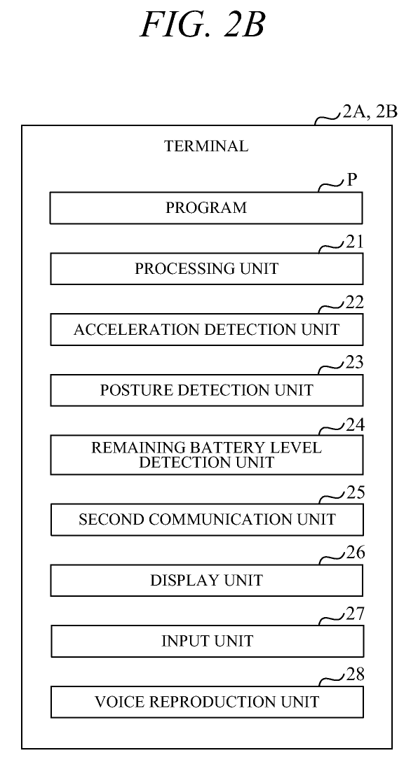

Hereinafter, the function of the in-vehicle device 14 serving as the driving diagnosis apparatus 200 will be mainly described. FIGS. 2A and 2B are diagrams describing a configuration example of each unit in FIG. 1.

### In-vehicle Device

FIG. 2A is a block diagram illustrating a configuration of a main part of the in-vehicle device 14. The in-vehicle device 14 includes a control unit 16 that substantially functions as a Micro Processing Unit (MPU) of the IVI system, and reads and executes a predetermined program P stored in a storage unit 17 to perform various information processing, control processing, and the like necessary in the in-vehicle device 14.

The program P may be downloaded from, for example, the server device 400 connected to the in-vehicle device 14 via the first communication unit 18 and the public communication network 300.

In FIG. 2A, the in-vehicle device 14 includes the control unit 16, the storage unit 17, and the first communication unit 18. In a case of starting the operation of the driving diagnosis apparatus 200, the control unit 16 reads and executes an application program for the driving diagnosis apparatus 200 among the programs P stored in the storage unit 17, thereby performing various types of information processing, control processing, and the like necessary for the driving diagnosis apparatus 200.

The control unit 16 includes, as a functional configuration for driving diagnosis, an acquisition unit 161, a generation unit 162, a diagnosis unit 163, a position detection unit 164, an unsuitability detection unit 165, an output unit 166, and an input unit 167.

### Acquisition Unit

The acquisition unit 161 acquires, via the first communication unit 18, first acceleration data serving as first information indicating the behavior of the vehicle 100 detected by the terminal 2A from the terminal 2A, and acquires second acceleration data serving as second information indicating the behavior of the vehicle 100 detected by the terminal 2B from the terminal 2B.

The acquisition unit 161 further acquires, via the first communication unit 18, first angular velocity data serving as first posture information indicating the posture of the terminal 2A fixed to the holder (not illustrated) from the terminal 2A, and acquires second angular velocity data serving as second posture information indicating the posture of the terminal 2B from the terminal 2B.

### Generation Unit

The generation unit 162 generates the driving evaluation value based on the first acceleration data and the first angular velocity data, as well as the second acceleration data and the second angular velocity data acquired by the acquisition unit 161.

First, the generation unit 162 scores the driving characteristics characterizing the way of driving of the driver P1 using the acceleration data detected by the terminal 2A and the terminal 2B. This is based on the idea that the way of driving is characterized by the stability of acceleration, the stability of deceleration, the stability of turning, and the stability of straight advancement serving as driving characteristics.

In the embodiment, among the accelerations detected by the terminal 2A and the terminal 2B, the acceleration with respect to the advancing direction of the vehicle 100 is made to correspond to the acceleration and deceleration of the vehicle 100. In addition, among the accelerations detected by the terminal 2A and the terminal 2B, an acceleration in a direction orthogonal to the advancing direction of the vehicle 100 is made to correspond to turning.

The generation unit 162 scores each of the stability of acceleration, the stability of deceleration, the stability of turning, and the stability of straight advancement as follows based on the change in direction and magnitude of the acceleration acquired in time series while the vehicle 100 is traveling.

### Stability of Acceleration

In the generation unit 162, for example, in a coordinate system of three axes (X-axis, Y-axis, Z-axis), an advancing direction of the vehicle 100 is defined as an X-axis, a left-right direction orthogonal to the X-axis is defined as a Y-axis, and an up-down direction orthogonal to the X-axis and the Y-axis is defined as a Z-axis. Then, when the acceleration of the X-axis component detected by the terminal 2A and the terminal 2B is positive, it is treated as acceleration, and when the acceleration of the X-axis component detected by the terminal 2A and the terminal 2B is negative, it is treated as deceleration.

Therefore, in the case of evaluating the stability of the acceleration, the generation unit 162 evaluates the magnitude only if the acceleration of the X-axis component is positive. Then, the maximum value of the acceleration is counted for each acceleration operation, and as the ratio of the large acceleration exceeding a predetermined first threshold value in one traveling increases, the score for the stability of the acceleration in the traveling is decreased.

### Stability of Deceleration

In the case of evaluating the stability of the deceleration, the generation unit 162 evaluates the magnitude only if the acceleration of the X-axis component is negative. Then, the maximum value of the absolute value of the acceleration is counted for each deceleration operation, and as the ratio of the large acceleration at which the absolute value exceeds a predetermined second threshold value in one traveling increases, the score for the stability of the deceleration in the traveling is decreased.

### Stability of Turning

In the case of evaluating the stability of the turning, the generation unit 162 evaluates the magnitude regardless of whether the acceleration of the Y-axis component is positive or negative. Then, the maximum value of the absolute value of the acceleration is counted for each turning operation in which the sign of the acceleration of the Y-axis component is the same, and as the ratio of the large acceleration at which the absolute value exceeds a predetermined third threshold value in one traveling increases, the score for the stability of the turning in the traveling is decreased.

### Stability of Straight Advancement

In the case of evaluating the stability of the straight advancement, the generation unit 162 evaluates that there is no so-called abrupt steering. When abrupt steering operation is performed, the acceleration of the Y-axis component in the vehicle 100 increases, and thus it is common with a case of evaluating the stability of the turning in that the acceleration of the Y-axis component is the evaluation target. However, the maximum value of the absolute value of the acceleration of the Y-axis component is counted only under the condition that there is no acceleration/deceleration for a certain period of time, in other words, the magnitude of the absolute value of the acceleration of the X-axis component being within a predetermined value is continued for a certain period of time, and the maximum value is not counted at the time of a normal right/left turn (operation of turning right/left after decelerating). In the evaluation of the stability of the straight advancement, as the ratio of a large acceleration at which the absolute value exceeds a predetermined fourth threshold value in one traveling increases, the score for the stability of the straight advancement in the traveling is decreased.

### Correction to Acceleration Data

The generation unit 162 corrects the first acceleration data based on the first angular velocity data, corrects the second acceleration data based on the second angular velocity data, and performs scoring of the driving characteristic as described above based on the corrected first acceleration data and the corrected second acceleration data. The reason for this is as follows.

In general, the coordinate system of the three axes (X-axis, Y-axis, Z-axis) related to the traveling of the vehicle 100 described above and the coordinate system of the three axes (x-axis, y-axis, z-axis) of the acceleration sensor in a case where the acceleration is detected by the terminal 2A fixed to the seat or the like (holder) of the vehicle 100 do not coincide with each other in many cases due to the direction in which the terminal 2A is fixed, and there is a relative deviation.

Therefore, before scoring the driving characteristics, the generation unit 162 converts the first acceleration data represented by three axes (x-axis, y-axis, z-axis) of the acceleration sensor of the terminal 2A into first acceleration data represented by three axes (X-axis, Y-axis, Z-axis) related to traveling of the vehicle 100 by using the first angular velocity data indicating the posture of the terminal 2A. This conversion may be referred to as calibration. That is, in the embodiment, the corrected first acceleration data is synonymous with the calibrated first acceleration data.

Similarly, before scoring the driving characteristics, the generation unit 162 converts the second acceleration data represented by three axes (x-axis, y-axis, z-axis) of the acceleration sensor of the terminal 2B into second acceleration data represented by three axes (X-axis, Y-axis, Z-axis) related to traveling of the vehicle 100 by using the second angular velocity data indicating the posture of the terminal 2B. In the embodiment, the corrected second acceleration data is synonymous with the calibrated second acceleration data.

### Change of Reference Threshold Value

In a case where the terminal detected by the position detection unit 164 is present at the rear seat, the generation unit 162 changes the reference threshold value (corresponding to the first to fourth threshold values) used for scoring the driving characteristics as follows, unlike the case where the terminal is detected at the front seat.

Specifically, the first to fourth threshold values in the scoring of the driving characteristics are corrected to values lower than the initial values. The correction width may be commonly set to the first threshold value to the fourth threshold value, or may be individually set to the first threshold value to the fourth threshold value.

As an example, the generation unit 162 corrects the first to fourth threshold values for the second acceleration data detected and calibrated by the terminal 2B used by the passenger P2 in the rear seat of the vehicle interior to be smaller than the first to fourth threshold values for the first acceleration data detected and calibrated by the terminal 2A used by the driver P1 in the front seat.

By such correction of the first to fourth threshold values, the score of the driving characteristic calculated based on the second acceleration data detected by the terminal 2B becomes lower than the score of the driving characteristic calculated based on the first acceleration data detected by the terminal 2A, and use of the detection data at the rear seat has a higher possibility of being determined as rougher driving.

Lastly, the generation unit 162 generates a driving evaluation value of the driver P1 based on the scores for driving characteristics (stability of acceleration, stability of deceleration, stability of turning, and stability of straight advancement) calculated based on the calibrated first acceleration data and the calibrated second acceleration data detected by the terminals 2A, 2B of a plurality of occupants of the vehicle 100.

The driving evaluation value of the driver P1 may be a score obtained by dividing a sum of the scores for the driving characteristics (stability of acceleration, stability of deceleration, stability of turning, and stability of straight advancement) calculated based on detection data detected by the terminals 2A and 2B of a plurality of occupants by the number of occupants.

Alternatively, the sum of the lowest scores for each stability among the scores for the driving characteristics (stability of acceleration, stability of deceleration, stability of turning, and stability of straight advancement) calculated based on the detection data detected by the terminals 2A and 2B of the plurality of occupants may be used as the driving evaluation value.

### Diagnosis Unit

The diagnosis unit 163 performs driving diagnosis of the driver P1 seated on the driver's seat of the vehicle 100 by using the driving evaluation value generated by the generation unit 162.

Note that, in the embodiment, as an example, when the driver P1 and the passenger P2 get on the vehicle 100, the in-vehicle device 14 may speak to the driver P1 and the passenger P2 via the voice reproduction units 53A to 53D constituting the output device 50, the microphones 111A and 111B constituting the input device 11 may collect voices (e.g., introducing one's own name) responded by the driver P1 and the passenger P2, and the front seat camera 131 and the rear seat camera 132 constituting the vehicle interior camera 13 may image the driver P1 and the passenger P2.

The in-vehicle device 14 associates (may be said to relate) the faces of the driver P1 and the passenger P2, the names of the driver P1 and the passenger P2, and the frequency components of the voice uttered by the driver P1 and the passenger P2, so that it is possible to identify the faces, the names, and the voices of all the occupants in the vehicle interior.

The in-vehicle device 14 records the information regarding the driving diagnosis of the driver P1 acquired as the driving diagnosis apparatus 200 in the storage unit 17 as a diagnosis result R, and manages the information as driving information of the driver P1. The diagnosis result R can be checked by the driver P1 via the output device 50 as a look-back of the driver's own driving while, for example, the vehicle 100 that has finished one travel is stopped.

### Position Detection Unit

The position detection unit 164 detects the positions of the terminal 2A and the terminal 2B in the vehicle 100. The detection method may be any of the following first example and second example.

### First Example

The position detection unit 164 detects the positions of the terminal 2A and the terminal 2B based on the radio wave of the UWB wireless communication received by the first communication unit 18.

### Second Example

The position detection unit 164 detects the positions of the terminal 2A and the terminal 2B based on an image photographed by the vehicle interior camera 13 for photographing an occupant in the vehicle interior.

The control unit 16 sets the terminal detected near the driver's seat in the front seat as the terminal 2A, and specifies the occupant using the terminal 2A as the driver P1 based on the ID information of the terminal 2A. Furthermore, the control unit sets the terminal detected near the seat that is not the driver's seat as the terminal 2B, and specifies the occupant using the terminal 2B as the passenger P2 based on the ID information of the terminal 2B.

### Unsuitability Detection Unit

The unsuitability detection unit 165 detects whether or not at least one of the terminal 2A and the terminal 2B is in an unsuitable situation not suitable for acquiring the first acceleration data and the second acceleration data indicating the behavior of the vehicle 100.

The unsuitable situation includes a case where a predetermined application for detecting the behavior of driving is not activated in the terminal 2A and/or the terminal 2B.

The unsuitable situation includes, for example, a case where the first communication unit 18 cannot perform wireless communication with the terminal 2A and/or the terminal 2B.

In addition, it may also include a case where a remaining battery level of the terminal 2A and/or the terminal 2B is lower than a predetermined value.

Furthermore, a case where the first angular velocity data serving as the first posture information acquired by the first communication unit 18 and/or the second angular velocity data serving as the second posture information acquired by the first communication unit 18 indicate that the terminal 2A and/or the terminal 2B is not held by the holder (not illustrated) may be included.

### Output Unit

In a case where the driver P1 checks the diagnosis result R by video, the output unit 166 outputs a video signal showing the diagnosis result R to the output device 50 upon receiving an instruction from the driver P1. As a result, the video based on the video signal output from the output unit 166 is displayed on the display unit constituting the output device 50.

Furthermore, in a case where the driver P1 checks the diagnosis result R by voice, the output unit 166 outputs a reproduction signal for notifying the output device 50 of the diagnosis result R by voice upon receiving an instruction from the driver P1. As a result, the voice based on the reproduction signal output from the output unit 166 is reproduced by the speaker or the like constituting the output device 50.

### Input Unit

The input unit 167 inputs voices uttered by the driver P1 and the passenger P2. More specifically, the voice signal of the driver P1 collected by the microphone 111A is input. Furthermore, the voice signal of the passenger P2 collected by the microphone 111B is input.

### First Communication Unit

The first communication unit 18 includes a short-range wireless communication module (not illustrated) that performs wireless communication with the terminals 2A and 2B and a wired communication module (not illustrated) that performs wired communication by CAN or the like. The UWB wireless communication system described above may be adopted for the short-range wireless communication module.

The vehicle sensor group 12, vehicle interior camera 13, the input device 11, and the output device 50 in FIG. 2A will be briefly described.

### Vehicle Sensor Group

The vehicle sensor group 12 includes a vehicle speed sensor, a positioning sensor, a camera, and the like. In the embodiment, the in-vehicle device 14 is configured to be able to obtain vehicle speed information of the vehicle 100 detected by the vehicle speed sensor.

### Vehicle Interior Camera

The vehicle interior camera 13 includes the front seat camera 131 and the rear seat camera 132. The front seat camera 131 photographs the upper body of the driver P1 sitting in the front seat, and outputs data of the subject image to the in-vehicle device 14 as image information. The rear seat camera 132 photographs the upper body of the passenger P2 sitting in the rear seat, and outputs data of the subject image to the in-vehicle device 14 as image information.

### Input Device

The input device 11 includes operation detection units 11A and 11B and microphones 111A and 111B.

The operation detection unit 11A is operated by the driver P1 in the front seat, and outputs an operation signal to the in-vehicle device 14. The operation detection unit 11A may be configured as a pointing device that interlocks with a projection image projected by the projection unit 52 described later. The operation detection unit 11B is provided on the display surface of the display unit 51. The operation detection unit 11B is operated by the passenger P2 in the rear seat and outputs an operation signal indicating a touch position to the in-vehicle device 14.

The microphone 111A collects voice uttered by the driver P1 in the front seat and outputs a voice signal to the in-vehicle device 14. The microphone 111B collects voice uttered by the passenger P2 in the rear seat and outputs a voice signal to the in-vehicle device 14.

### Output Device

The output device 50 includes the display unit 51, the projection unit 52, and the voice reproduction unit 53. The output device 50 is used, for example, for displaying an operation menu screen, reproducing the diagnosis result R, or the like.

The display unit 51 has a screen such as a liquid crystal display, and displays image information based on a display signal output from the in-vehicle device 14. The image information includes an operation menu screen, an image of the diagnosis result R, and the like.

The projection unit 52 includes, for example, a head-up display (HUD) to be projected on a windshield or the like, and projects image information based on a projection signal output from the in-vehicle device 14. The image information includes an operation menu screen, an image of the diagnosis result R, and the like.

The voice reproduction units 53A to 53D are configured as speakers that reproduce and output voice and the like, and reproduce voice and the like based on a reproduction signal output from the in-vehicle device 14. Note that a voice output unit that outputs a voice reproduction signal to a headphone (not illustrated) or the like may be provided.

### Terminal

FIG. 2B is a block diagram illustrating a configuration of a main part of the terminal 2A. Since the configuration of the terminal 2B is similar to that of the terminal 2A, illustration thereof will be omitted. The terminal 2A includes a processing unit 21 such as an MPU, and reads and executes a predetermined program P (which may also be referred to as an application) stored in a storage unit (not illustrated) to perform various types of information processing, control processing, and the like necessary for the functional configurations described below.

The terminal 2A includes, as functional configurations, an acceleration detection unit 22, a posture detection unit 23, a remaining battery level detection unit 24, and a second communication unit 25.

Note that the smartphone generally includes the display unit 26, the input unit 27, the voice reproduction unit 28, and the like, but the description thereof will be omitted.

Furthermore, for example, the terminal 2A may share a function in combination with another device such as a smart watch.

### Acceleration Detection Unit

The acceleration detection unit 22 detects accelerations in three axes (corresponding to x-axis, y-axis, and z-axis), and sends each detection signal to the in-vehicle device 14 via the second communication unit 25 as a set of first acceleration data.

### Posture Detection Unit

The posture detection unit 23 includes, for example, a gyro sensor. The posture detection unit 23 detects each angular velocity of rotation in the three axes (corresponding to x-axis, y-axis, and z-axis), and sends each of the detection signals as a set of first angular velocity data to the in-vehicle device 14 via the second communication unit 25. Since the posture of the terminal 2A can be calculated using the first angular velocity data, the first angular velocity data may be referred to as first posture information. The first posture information is information essential for calibration of the first acceleration data.

### Remaining Battery Level Detection Unit

The remaining battery level detection unit 24 detects the remaining level of a battery (not illustrated) that supplies power consumed by the terminal 2A, and sends a detection signal to the in-vehicle device 14 via the second communication unit 25.

### Second Communication Unit

The second communication unit 25 includes a UWB wireless communication module (not illustrated) that performs wireless communication with the in-vehicle device 14.

### Description of Flowchart

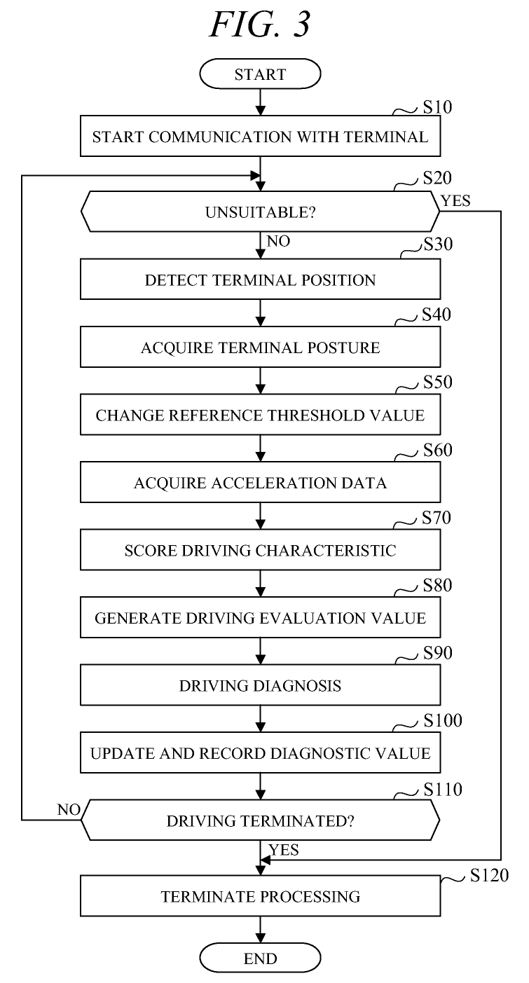

FIG. 3 is a flowchart describing an example of driving diagnosis processing by a program executed by the MPU (control unit 16) of the in-vehicle device 14. For example, when the “driving diagnosis” button is operated on the operation menu screen (not illustrated), the control unit 16 of the in-vehicle device 14 executes a program for causing the IVI system to function as the driving diagnosis apparatus 200.

In S10 (S: processing step) of FIG. 3, the control unit 16 causes the first communication unit 18 to start communication with the terminal 2A and the like in the vehicle interior, and proceeds to S20.

In S20, the control unit 16 detects whether or not it is an unsuitable situation that is not suitable for acquiring the first acceleration data or the like indicating the behavior of the vehicle 100. The control unit 16 makes an affirmative determination in S20 in a case where it is unsuitable, and proceeds to S120. In this case, the driving diagnosis processing is stopped based on the idea that it is preferable to stop the diagnosis rather than to obtain a wrong diagnostic value. In a case where it is not unsuitable, the control unit 16 makes a negative determination in S20 and proceeds to S30.

In S30, the control unit 16 causes the position detection unit 164 to detect the position of the communicable terminal 2A and the like in the vehicle interior, and proceeds to S40. The control unit 16 specifies an occupant using the terminal 2A as the driver P1 based on, for example, ID information of the terminal 2A detected in the vicinity of the driver's seat in the front seat.

In S40, the control unit 16 detects the posture of the terminal 2A and the like in the vehicle interior via the first communication unit 18, and proceeds to S50. In the embodiment, first angular velocity data and second angular velocity data serving as posture information are acquired from the terminals 2A and 2B.

In S50, the control unit 16 changes the reference threshold value and proceeds to S60. As described above, the reference threshold is changed by correcting the reference threshold value (corresponding to the first threshold value to the fourth threshold value) used for scoring the driving characteristics based on the detection data by the terminal to a value lower than the initial value in a case where the terminal is detected in the rear seat.

In S60, the control unit 16 acquires the first acceleration data and the second acceleration data serving as the acceleration information from each of the terminals 2A and 2B in the vehicle interior via the first communication unit 18, and proceeds to S70.

In S70, the control unit 16 causes the generation unit 162 to score the driving characteristic (stability of acceleration, stability of deceleration, stability of turning, and stability of straight advancement), and proceeds to S80. As described above, the scoring of the driving characteristic is performed based on the calibrated first acceleration data and the calibrated second acceleration data.

In S80, the control unit 16 causes the generation unit 162 to generate the driving evaluation value of the driver P1 based on each score for the driving characteristic (stability of acceleration, stability of deceleration, stability of turning, and stability of straight advancement), and proceeds to S90.

In S90, the control unit 16 causes the diagnosis unit 163 to perform driving diagnosis of the driver P1 using the driving evaluation value generated by the generation unit 162, and proceeds to S100.

In S100, the control unit 16 updates and records the diagnostic value (diagnosis result) for the driver P1, and proceeds to S110. For example, the control unit 16 records, as the diagnosis result R, when and where the driver P1 of the vehicle 100 traveled, what driving characteristic the driver P1 had, what was the rating on that driving characteristic, what was the diagnostic value, and the like in the storage unit 17 in the control unit 16 for each driver as the driving information. In S100, updating and recording of adding the latest driving information to such driving information for each driver are performed.

In S110, the control unit 16 determines whether or not the driving is terminated. In a case where the predetermined terminating operation is performed, the control unit 16 makes an affirmative determination in S110 and proceeds to S120. In a case where the terminating operation is not performed, the control unit 16 makes a negative determination in S110 and returns to S20. In the case of returning to S20, the control unit 16 repeats the above-described processing.

In S120, the control unit 16 performs predetermined terminating processing and terminates the processing according to FIG. 3. The terminating processing includes, as an example, termination of acquisition of acceleration information and termination of wireless communication with the terminals 2A and 2B by the first communication unit 18. Note that the wireless communication with the terminals 2A and 2B by the first communication unit 18 may not be terminated if it is required in other processing other than the driving diagnosis processing.

According to the embodiment described above, the following effects are obtained.

(1) The driving diagnosis apparatus 200 includes a first communication unit 18 that performs communication with a terminal 2A serving as a first information terminal possessed by a driver P1 serving as a first occupant riding in a vehicle 100 and a terminal 2B serving as a second information terminal possessed by a passenger P2 serving as a second occupant riding in the vehicle 100, an acquisition unit 161 that acquires, via the first communication unit 18, first acceleration data serving as first information indicating a behavior of the vehicle 100 detected by the terminal 2A and second acceleration data serving as second information indicating a behavior of the vehicle detected by the terminal 2B, a generation unit 162 that generates a driving evaluation value based on the first acceleration data and second acceleration data acquired by the acquisition unit 161, and a diagnosis unit 163 that performs driving diagnosis of the driver P1 driving the vehicle 100 using the driving evaluation value generated by the generation unit 162.

With this configuration, it is possible to perform an appropriate driving diagnosis based on the behavior of the vehicle 100 felt by a plurality of occupants. For example, it is possible to perform driving diagnosis based on the acceleration actually felt by each occupant by using the accelerations detected by the terminal 2A and the terminal 2B used by each occupant. In addition, by using the acceleration detected by the terminal 2B of the passenger P2 other than the driver P1, for example, it is possible to cause the driver P1 to be aware of the rough driving that is difficult to recognize by oneself.

(2) The driving diagnosis apparatus 200 of (1) further includes a position detection unit 164 that detects a first position of the terminal 2A and a second position of the terminal 2B in the vehicle 100, in which the terminal 2A and the terminal 2B each detect the behavior of the vehicle 100 at the first position and the second position detected by the position detection unit 164, and output the first acceleration data and the second acceleration data to the first communication unit 18.

With this configuration, it is possible to perform precise driving diagnosis according to the difference in the acceleration data detected by the terminal 2A and the acceleration data detected by the terminal 2B. More specifically, the driving diagnosis apparatus 200 can perform diagnosis using the acceleration data detected by the terminal 2A and the terminal 2B at each of the positions in the vehicle interior.

(3) In the driving diagnosis apparatus 200 of (2), in a case where the second position is a position corresponding to the rear seat, the diagnosis unit 163 lowers the reference threshold value of the evaluation at the time of driving diagnosis as compared with the case where the second position is a position corresponding to the front seat.

With this configuration, for example, the score of the driving characteristic calculated based on the second acceleration data detected by the terminal 2B located in the rear seat is lower than the score of the driving characteristic calculated based on the first acceleration data detected by the terminal 2A located in the front seat, and the use of the detection data in the rear seat is more likely to be determined to be rougher driving.

(4) The driving diagnosis apparatus 200 of (2) further includes the vehicle interior camera 13 that photographs the driver P1 and the passenger P2, and the position detection unit 164 detects the first position and the second position based on the image photographed by the vehicle interior camera 13.

With this configuration, the positions of the driver P1 (terminal 2A) and the passenger P2 (terminal 2B) can be directly obtained from the image in which the driver P1 (terminal 2A) and the passenger P2 (terminal 2B) appear.

(5) In the driving diagnosis apparatus 200 of (2), the first communication unit 18 transmits and receives a signal conforming to the UWB wireless communication standard between the terminal 2A and the terminal 2B, and the position detection unit 164 detects the first position and the second position based on the radio wave received by the first communication unit 18.

With this configuration, the positions of the terminal 2A and the terminal 2B can be obtained based on the received radio wave of the UWB wireless communication. In addition, the position can be accurately detected as compared with positioning using Bluetooth (registered trademark).

(6) The driving diagnosis apparatus 200 of (1) further includes an unsuitability detection unit 165 that detects whether or not at least one of the terminal 2A and the terminal 2B is in an unsuitable situation not suitable for acquiring information indicating the behavior of the vehicle 100, and the diagnosis unit 163 stops the driving diagnosis in a case where the unsuitable situation is detected by the unsuitability detection unit 165.

With this configuration, if there is a possibility that a signal cannot be stably received from the terminal 2A and/or the terminal 2B, reliability of the diagnosis function can be secured by stopping the driving diagnosis.

(7) In the driving diagnosis apparatus 200 of (1), the acquisition unit 161 further acquires first angular velocity data as serving as first posture information indicating the posture of the placed terminal 2A and second angular velocity data serving as second posture information indicating the posture of the placed terminal 2B via the first communication unit 18, and the generation unit 162 further corrects the first acceleration data based on the first angular velocity data, corrects the second acceleration data based on the second angular velocity data, and generates a driving evaluation value based on the corrected first acceleration data and corrected second acceleration data.

With this configuration, the terminal 2A and/or the terminal 2B can correctly correct the first acceleration data and the second acceleration data indicating the driving behavior in any posture such as front and back or oblique. As a result, it is possible to appropriately score the driving characteristics that characterize the way of driving of the driver P1.

The above-described embodiments may be modified into various modes. Hereinafter, modified examples will be described.

### First Modified Example

In the above-described embodiment, an example in which the in-vehicle device 14 of the vehicle 100 is caused to perform the driving diagnosis processing has been described, but the driving diagnosis processing may be configured to be performed by the terminal 2A used by the driver P1.

At that time, the terminal 2A used by the driver P1 and the terminal 2B used by the passenger P2 communicate with each other via wireless communication such as a public communication network using a mobile line, Wi-Fi (registered trademark), Bluetooth (registered trademark), or UWB, and the driving diagnosis processing is performed. This may be performed via a server device, or data may be directly exchanged between the terminals 2A and 2B.

As a result, since the diagnosis processing can be performed by the terminal 2A of the driver P1 without depending on the in-vehicle device 14, it is not necessary to install an expensive device for each vehicle, and the cost can be reduced. In addition, since it is possible to collect and analyze driving diagnosis data at an early stage by using wireless communication, it is also possible to improve the real-time property with respect to the driving diagnosis and to achieve integrated management of the data.

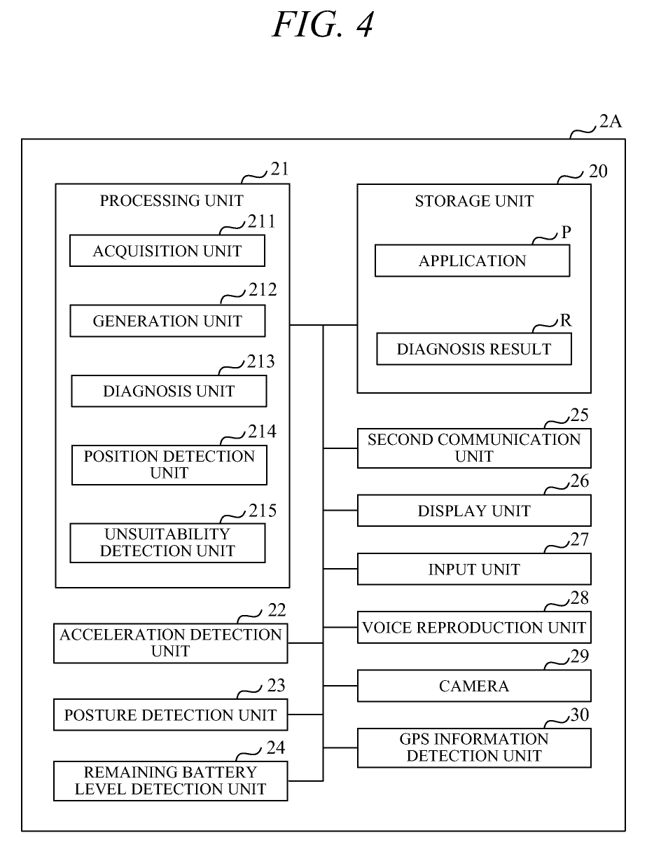

FIG. 4 is a block diagram illustrating a configuration of a main part of the terminal 2A that executes driving diagnosis processing according to a first modified example. Since the configuration of the terminal 2B is similar to that of the terminal 2A, illustration thereof will be omitted.

In FIG. 4, the terminal 2A includes a storage unit 20, a processing unit 21, an acceleration detection unit 22, a posture detection unit 23, a remaining battery level detection unit 24, a second communication unit 25, a display unit 26, an input unit 27, a voice reproduction unit 28, a camera 29, and a GPS information detection unit 30.

The storage unit 20 includes a storage element such as a Random Access Memory (RAM) or a Read Only Memory (ROM), and stores an application P for the driving diagnosis apparatus 200 necessary for the processing unit 21 to execute processing. The storage unit 20 further stores information related to the driving diagnosis of the driver P1 acquired by the driving diagnosis processing as a diagnosis result R.

Note that the application P is downloaded to the terminal 2A in advance via the second communication unit 25 and the public communication network 300.

The processing unit 21 includes an arithmetic processing device such as a CPU and an MPU, and performs various types of information processing, control processing, and the like necessary for the terminal 2A by reading and executing the application P.

The processing unit 21 includes, as functional configurations for the driving diagnosis, an acquisition unit 211, a generation unit 212, a diagnosis unit 213, a position detection unit 214, and an unsuitability detection unit 215.

The acquisition unit 211 acquires first acceleration data serving as first information indicating the behavior of the vehicle 100 from the acceleration detection unit 22, and acquires second acceleration data serving as second information indicating the behavior of the vehicle 100 detected by the acceleration detection unit 22 of the terminal 2B from the terminal 2B via the second communication unit 25.

The acquisition unit 211 further acquires first angular velocity data serving as first posture information indicating the posture of the terminal 2A from the posture detection unit 23, and acquires second angular velocity data serving as second posture information indicating the posture of the terminal 2B detected by the posture detection unit 23 of the terminal 2B from the terminal 2B via the second communication unit 25.

The generation unit 212 generates the driving evaluation value based on the first acceleration data and the first angular velocity data acquired by the acquisition unit 211, as well as the second acceleration data and the second angular velocity data acquired by the acquisition unit 211.

The generation unit 212 performs processing similar to that of the generation unit 162 described above, thereby generating the driving evaluation value of the driver P1 based on each score for the driving characteristic (stability of acceleration, stability of deceleration, stability of turning, and stability of straight advancement) calculated based on the calibrated first acceleration data and the calibrated second acceleration data detected by the terminals 2A and 2B of a plurality of occupants of the vehicle 100.

The diagnosis unit 213 performs processing similar to that of the diagnosis unit 163 described above, thereby performing driving diagnosis of the driver P1 seated on the driver's seat of the vehicle 100 by using the driving evaluation value generated by the generation unit 212.

The position detection unit 214 detects the positions of the terminal 2A and the terminal 2B in the vehicle 100. The detection method may be any of the following first example and second example.

### First Example

The position detection unit 214 detects, for example, the positions of the in-vehicle device 14 and the terminal 2B based on the radio wave of the UWB wireless communication received by the second communication unit 25. Then, a positional relationship with the terminal 2A is indirectly detected.

### Second Example

The position detection unit 214 acquires an image photographed by the vehicle interior camera 13 that photographs an occupant in the vehicle interior from the in-vehicle device 14 via the second communication unit 25, and detects position information of the terminal 2A and the terminal 2B based on the acquired image.

In the first modified example, the processing unit 21 sets the terminal detected in the vicinity of the driver's seat as the terminal 2A, and specifies the occupant using the terminal 2A as the driver P1 based on the ID information of the terminal 2A. Furthermore, the control unit sets the terminal detected near the seat that is not the driver's seat as the terminal 2B, and specifies the occupant using the terminal 2B as the passenger P2 based on the ID information of the terminal 2B.

The unsuitability detection unit 215 detects whether or not at least one of the terminal 2A and the terminal 2B is in an unsuitable situation not suitable for acquiring the first acceleration data and the second acceleration data indicating the behavior of the vehicle 100.

The unsuitable situation includes a case where a predetermined application P for detecting the behavior of driving is not activated in the terminal 2A and/or the terminal 2B.

The unsuitable situation includes a case where the terminal 2A and the terminal 2B cannot perform wireless communication.

In addition, it may also include a case where a remaining battery level of the terminal 2A and/or the terminal 2B is lower than a predetermined value.

Furthermore, a case where the first angular velocity data serving as the first posture information acquired by the acquisition unit 211 and/or the second angular velocity data serving as the second posture information acquired by the acquisition unit 211 indicate that the terminal 2A and/or the terminal 2B is not held by the holder (not illustrated) may be included.

The acceleration detection unit 22 to the voice reproduction unit 28 are similar to the acceleration detection unit 22 to the voice reproduction unit 28 described with reference to FIG. 2B.

The camera 29 is configured to be capable of photographing a situation inside the vehicle interior. The GPS information detection unit 30 detects the current position of the terminal 2A serving as the traveling position of the vehicle 100 based on positioning signals from a Global Positioning System (GPS) satellite, a quasi-zenith satellite, or the like.

### Second Modified Example

In the above-described embodiment, an example has been described in which, in a case where the terminal 2B is detected in the rear seat, the reference threshold value (corresponding to the first threshold value to the fourth threshold value) used for scoring the driving characteristics based on the detection data by the terminal 2B is corrected to a value lower than the initial value. Alternatively, an occupant who is likely to get carsick (in other words, the terminal used by the occupant) may be registered in advance, and the reference threshold value (corresponding to the first threshold value to the fourth threshold value) used for scoring the driving characteristics based on the detection data by the registered terminal may be corrected to a value lower than the initial value.

According to the second modified example, it is possible to perform driving diagnosis based on how an occupant who is likely to get carsick feels.

The above embodiment can be combined as desired with one or more of the aforesaid modifications. The modifications can also be combined with one another.

According to the present invention, it becomes possible to perform an appropriate driving diagnosis based on the behavior of the vehicle felt by a plurality of occupants.

Above, while the present invention has been described with reference to the preferred embodiments thereof, it will be understood, by those skilled in the art, that various changes and modifications may be made thereto without departing from the scope of the appended claims.

1. A driving diagnosis apparatus, comprising:
an in-vehicle device provided in a vehicle and including a processor and a memory coupled to the processor, wherein
the in-vehicle device is configured to perform:
performing communication with a first information terminal possessed by a first occupant riding in the vehicle and a second information terminal possessed by a second occupant riding in the vehicle;
acquiring, through the communication, first information indicating a behavior of the vehicle detected by the first information terminal and second information indicating the behavior of the vehicle detected by the second information terminal;
generating a driving evaluation value based on the first information and the second information; and
performing a driving diagnosis of the first occupant driving the vehicle using the driving evaluation value.

2. The driving diagnosis apparatus according to claim 1, wherein
the in-vehicle device is further configured to perform:
detecting a first position of the first information terminal in the vehicle and a second position of the second information terminal in the vehicle, wherein
the first information terminal and the second information terminal each detect the behavior of the vehicle at the first position and the second position, and transmit the first information and the second information to the in-vehicle device.

3. The driving diagnosis apparatus according to claim 2, wherein
in a case where the second position is a position corresponding to a rear seat, the in-vehicle device is configured to lower a reference threshold value of the driving diagnosis as compared with a case where the second position is a position corresponding to a front seat.

4. The driving diagnosis apparatus according to claim 2, further comprising:
a camera configured to capture an image of the first occupant and the second occupant, wherein
the in-vehicle device is configured to detect the first position and the second position based on the image.

5. The driving diagnosis apparatus according to claim 2, wherein:
the in-vehicle device is configured to transmit and receive a signal conforming to the UWB wireless communication standard between the first information terminal and the second information terminal, and detect the first position and the second position based on a radio wave of the UWB wireless communication.

6. The driving diagnosis apparatus according to claim 1, wherein
the in-vehicle device is further configured to perform:
detecting whether or not at least one of the first information terminal and the second information terminal is in an unsuitable situation not suitable for acquiring information indicating the behavior of the vehicle, wherein
the in-vehicle device is configured to stop the driving diagnosis when the unsuitable situation is detected.

7. The driving diagnosis apparatus according to claim 1, wherein
the in-vehicle device is configured to acquire, through the communication, first posture information indicating a posture of the first information terminal placed in the vehicle and second posture information indicating a posture of the second information terminal placed in the vehicle, correct the first information based on the first posture information, correct the second information based on the second posture information, and generate the driving evaluation value based on the first information corrected and the second information corrected.

8. The driving diagnosis apparatus according to claim 1, wherein
the in-vehicle device is configured to store information related to the driving diagnosis as a diagnostic result, and output the information so as to be viewable by the first occupant while the vehicle is stopped.

9. A non-transitory computer-readable recording medium storing a driving diagnosis program that, when executed by a computer, causes the computer to perform:
performing communication with a first information terminal possessed by a first occupant riding in a vehicle and a second information terminal possessed by a second occupant riding in the vehicle;
acquiring, through the communication, first information indicating a behavior of the vehicle detected by the first information terminal and second information indicating the behavior of the vehicle detected by the second information terminal;
generating a driving evaluation value based on the first information and the second information; and
performing a driving diagnosis of the first occupant driving the vehicle using the driving evaluation value.
